(19) United States
(12) Patent Application Publication
(10) Pub. No.: US 2016/0307693 A1
(43) Pub. Date: Oct. 20, 2016

(54) ELECTRONIC COMPONENT AND MANUFACTURING METHOD THEREOF

(71) Applicant: SAMSUNG ELECTRO-MECHANICS CO., LTD., Suwon-si (KR)

(72) Inventors: Tai Yon Cho, Suwon-si (KR); Doo Young Kim, Suwon-si (KR); Sang Ho Shin, Suwon-si (KR); Jun Ah, Suwon-si (KR); Woo Kyung Sung, Suwon-si (KR)

(21) Appl. No.: 15/001,001

(22) Filed: Jan. 19, 2016

(30) Foreign Application Priority Data
Apr. 16, 2015 (KR) 10-2015-0054076

(51) Int. Cl. H01F 27/29; H01F 41/04; H01F 41/02; H01F 27/28

(52) U.S. Cl. CPC H01F 27/29; H01F 27/2804; H01F 41/041; H01F 41/0246

(57) ABSTRACT

An electronic component includes a coil including lead terminals plated with a metal; a body part filling a space around the coil; and external electrodes connected to the lead terminals of the coil. At least portions of the lead terminals of the coil are exposed externally of the body part.

### CROSS-REFERENCE TO RELATED APPLICATION

This application claims the benefit of priority to Korean Patent Application No. 10-2015-0054076, filed on Apr. 16, 2015 with the Korean Intellectual Property Office, the entirety of which is incorporated herein by reference.

### TECHNICAL FIELD

The present disclosure relates to an electronic component having a coil embedded therein, and a manufacturing method thereof.

### BACKGROUND

An inductor, an electronic component, is a type of passive element that can be used together with a resistor and a capacitor to configure an electronic circuit to remove noise therefrom. The inductor may be combined with the capacitor through electromagnetism to configure a resonance circuit amplifying a signal in a specific frequency band, a filter circuit, or the like.

Recently, the miniaturization and thinning of information technology (IT) devices such as various communications devices, display devices, or the like, has been accelerated. In accordance with this, research into a technology for miniaturizing and thinning various elements such as inductors, capacitors, transistors, and the like, that are used in such IT devices, has also been continuously conducted.

In this regard, inductors have been rapidly replaced by relatively smaller inductors having higher density and capable of being automatically surface-mounted. In particular, a power inductor may be used in a power supply circuit, a converter circuit, or the like, through which a high level of current flows.

### SUMMARY

An aspect of the present disclosure provides an electronic component having a coil embedded therein and a manufacturing method thereof. More particularly, an aspect of the present disclosure provides a technology capable of improving electrical resistance characteristics by connecting internal electrodes and external electrodes to each other using a metallic bond.

According to an aspect of the present disclosure, an electronic component includes: a coil including lead terminals plated with a metal; a body part filling a space around the coil; and external electrodes connected to the lead terminals of the coil, wherein at least portions of the lead terminals of the coil are exposed externally of the body part.

The lead terminals of the coil may be metallically bonded to the external electrodes by electroplating or electroless plating.

The external electrodes may be formed on lower and side surfaces of the body part in an L-shape to thereby be connected to the lead terminals.

The external electrodes may be formed on a lower surface of the body part to thereby be connected to the lead terminals.

The coil may be a winding coil having at least one turn.

Pre-plating layers formed using Cu plating may be formed on the lead terminals of the coil.

The external electrodes may be formed by applying at least one of Ni and Sn to the pre-plating layers or by applying at least one of Ag and Cu to the pre-plating layers and then applying at least one of Ni and Sn thereto.

The electronic component may further include a support member in which the coil is disposed or fixed to an at least partially processed space.

The body part may be formed of a magnetic material-resin composite in which a magnetic metal powder and a resin mixture are mixed with each other, such that the coil may be embedded therein.

The magnetic material-resin composite may be molded in sheet form, stacked on at least one surface of the support member, compressed, and then cured.

According to another aspect of the present disclosure, a manufacturing method of an electronic component includes steps of: seating a coil in an at least partially processed space of a pre-manufactured support member; adding a magnetic material-resin composite to the support member and a space around the coil, and compressing and curing the added magnetic material-resin composite; exposing at least portions of lead terminals of the coil to plating a metal on the exposed portions; and forming external electrodes connected to the lead terminals of the coil.

The external electrodes may be formed on lower and side surfaces of the body part in an L-shape to thereby be connected to the lead terminals.

The external electrodes may be formed on a lower surface of the body part to thereby be connected to the lead terminals.

The coil may be a winding coil having at least one turn.

In the step of plating the metal, pre-plating layers may be formed on the lead terminals of the coil using Cu plating.

In the step of forming the external electrodes, the external electrodes may be formed by applying at least one of Ni and Sn to the lead terminals of the coil or by applying at least one of Ag and Cu to the lead terminals of the coil and then applying at least one of Ni and Sn thereto.

The step of plating the metal may include: exposing at least portions of the lead terminals of the coil externally; and plating the metal on the lead terminals of the coil exposed externally.

The step of adding the magnetic material-resin composite and compressing and curing the added magnetic material-resin composite may include: compressing and curing a first magnetic sheet formed by molding the magnetic material-resin composite in which a magnetic metal powder and a resin mixture are mixed with each other in sheet form on an upper surface of the support member; and compressing and curing a second magnetic sheet formed by molding the magnetic material-resin composite in sheet form on a lower surface of the support member.

According to the exemplary embodiments, the internal and external electrodes may be connected to each other by the metallic bond, such that direct current resistance and direct current resistance value distribution may be significantly decreased.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a structure of an electronic component according to an exemplary embodiment in the present disclosure;

FIG. 2 is an enlarged view of region A of FIG. 1;

FIGS. 3 and 4 are views illustrating a structure of external electrodes according to another exemplary embodiment;

FIG. 5 is a view illustrating a structure of external electrodes according to another exemplary embodiment;

FIGS. 6 through 8 are process views sequentially illustrating a manufacturing method of an electronic component according to an exemplary embodiment; and

FIG. 9 is a view illustrating a coil of an electronic component according to another exemplary embodiment.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

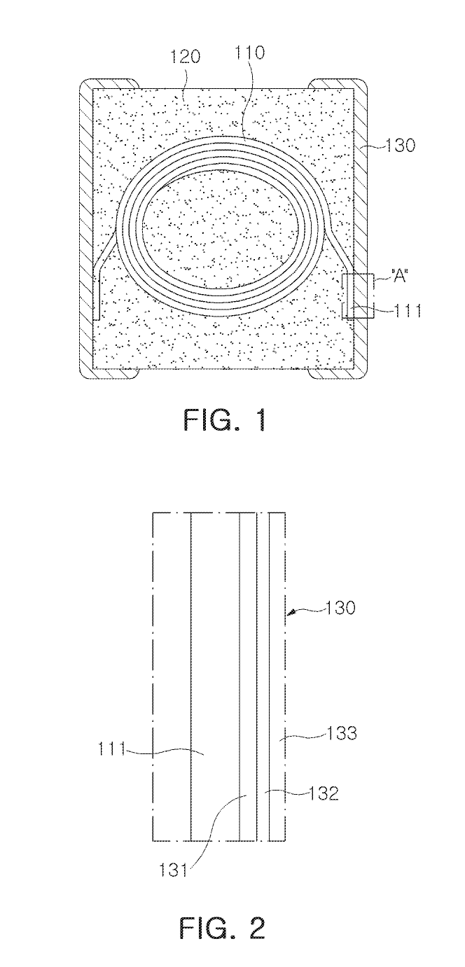

FIG. 1 is a view illustrating a structure of an electronic component according to an exemplary embodiment.

Referring to FIG. 1, the electronic component according to the exemplary embodiment may include a coil 110, a body part 120, and external electrodes 130. For example, an inductor may be used as the electronic component, and the inductor may be a representative passive element configuring an electronic circuit, together with a resistor and a capacitor, to remove noise therefrom.

The coil 110, which is an internal electrode installed in the body part 120 of the electronic component, may be formed of at least one metal selected from Ni, Al, Fe, Cu, Ti, Cr, Au, Ag, Pd, and Pt, which have excellent conductivity, and may have a coil structure in which coils are stacked with at least one ceramic sheet interposed therebetween.

One or more lead terminals 111 plated with a metal may be formed in the coil 110, and at least portions of the lead terminals 111 may be exposed externally of the body part 120 to thereby be electrically connected to the external electrodes.

For example, the coil 110 may be a winding coil formed having at least one turn formed by a winding method. In addition, a core may be formed in a central hole of the coil 110 in order to provide a high inductance inductor.

The lead terminals 111 of the coil 110 may be plated with a metal. For example, pre-plating layers formed by copper (Cu) plating, or the like, may be formed.

The body part 120, forming an exterior of the inductor while filling an internal portion of the electronic component, may fill a space around the coil 110. The body part 120 as described above may be formed of a magnetic material-resin composite in which a magnetic metal powder and a resin mixture are mixed with each other, such that the coil 110 may be embedded therein.

In this case, the magnetic metal powder may contain Fe, Cr, or Si as a main ingredient. More specifically, the magnetic metal powder may contain Fe—Ni, amorphous Fe, Fe, Fe—Cr—Si, and the like. In addition, the resin mixture may contain at least one of an epoxy, polyimide, and a liquid crystal polymer (LCP), or a combination thereof.

Magnetic metal powder particles having at least two particle sizes may be filled in the body part 120. According to exemplary embodiments, the magnetic material-resin composite may be completely filled by using bimodal magnetic metal powder particles having different sizes to compress the bimodal magnetic metal powder particles, thereby increasing the filling rate.

Particularly, in the magnetic material-resin composite, the magnetic metal powder and the resin mixture may be molded in sheet form, stacked on at least one surface of a support member, compressed, and then cured. For example, the body part 120 may contain a material for obtaining high magnetic characteristics of a coil inductor and DC-bias. For example, coarse powder and fine powder containing Fe, Cr, or Si as a main ingredient may be used as the magnetic metal powder particles, and an epoxy based resin may be used as the resin mixture. Therefore, a sheet having a predetermined thickness may be formed.

In this case, at least portions of the lead terminals 111 of the coil 110 may be exposed externally of the body part 120, and the lead terminals 111 may be exposed to surfaces of the body part 120 by physically, optically, or chemically deforming and removing at least portions of the body part 120.

The electronic component may further include a support member in which the coil 110 is disposed or fixed to an at least partially processed space. The at least partially processed space may be formed in the support member, and the space may have a sufficient size for accommodating the coil 110 therein. In this case, forming a cavity by ‘processing’ at least a portion of the support member may include forming the cavity through a structure using two or more support members as well as forming the cavity by physically, optically, or chemically deforming or removing at least a portion of the support member.

In this case, various boards may be used as the support member. The support member may use a material capable of being easily cut and processed and being mounted without misalignment of the coil 110, and a material for preventing positions of the coil 110 from changing and preventing a cured bar from being deformed due to deformation of sheets during compressing and filling the sheets may be used. For example, as the support member, a copper clad lamination (CCL), a rolled copper plate, a NiFe rolled copper plate, a Cu alloy plate, a ferrite board, a flexible board, or the like, may be used. Here, the ferrite board may be used as the support member instead of a printed circuit board (PCB), and the ferrite board may increase permeability to thereby improve inductance characteristics. Furthermore, the ferrite board may increase permeability of ferrite and more stably fix the coil 110.

The external electrodes 130 may be connected to the lead terminals 111 of the coil 110 using a metallic bond. Here, the lead terminals 111 of the coil 110 may be metallically bonded to the external electrodes 130 by electroplating or electroless plating.

In this case, the external electrodes 130 may contain a metal such as Ag, Ag—Pd, Ni, Cu, or the like, and Ni plating layers and Sn plating layers may be selectively formed on surfaces of the external electrodes 130.

FIG. 2 is an enlarged view of part A of FIG. 1.

Referring to FIG. 2, one or more lead terminals 111 plated with the metal may be formed in the coil 110, and at least portions of the lead terminals 111 of the coil 110 may be exposed externally of the body part 120 to thereby be connected to the external electrodes 130.

The lead terminals 111 of the coil 110 may be directly metallically bonded to the external electrodes 130 by plating the metal without using a conductive paste, or the like.

In this case, the external electrodes 130 may contain the metal such as Ag, Ag—Pd, Ni, Cu, or the like, and the Ni plating layers and the Sn plating layers may be selectively formed on the surfaces of the external electrodes 130.

That is, plating layers 131 formed by directly plating the metal may be formed on the lead terminals 111 of the coil 110. For example, pre-plating layers by copper (Cu) plating, or the like, may be formed. In addition, the external electrodes 130 may be formed by applying at least one of Ni and Sn to the plating layers or by applying at least one of Ag and Cu to the plating layers and then applying at least one of Ni and Sn thereto. For example, plating layers 131 formed by directly plating a metal may be formed on external surfaces of lead terminals 111 of a Cu coil, and Ni plating layers 132 and Sn layers 133 may be applied thereto, thereby forming the external electrodes 130.

Mechanical and electrical properties generated using a conductive paste may be improved by directly connecting the internal electrode (coil) exposed externally of the body part and portions of the body part to the external electrodes by the metallic bond formed through plating as described above.

In this case, direct current resistance and direct current resistance value distribution may be significantly reduced by connecting the internal and external electrodes to each other by the metallic bond as compared to a case of connecting the internal electrodes using a conductive paste and then forming the external electrodes through plating.

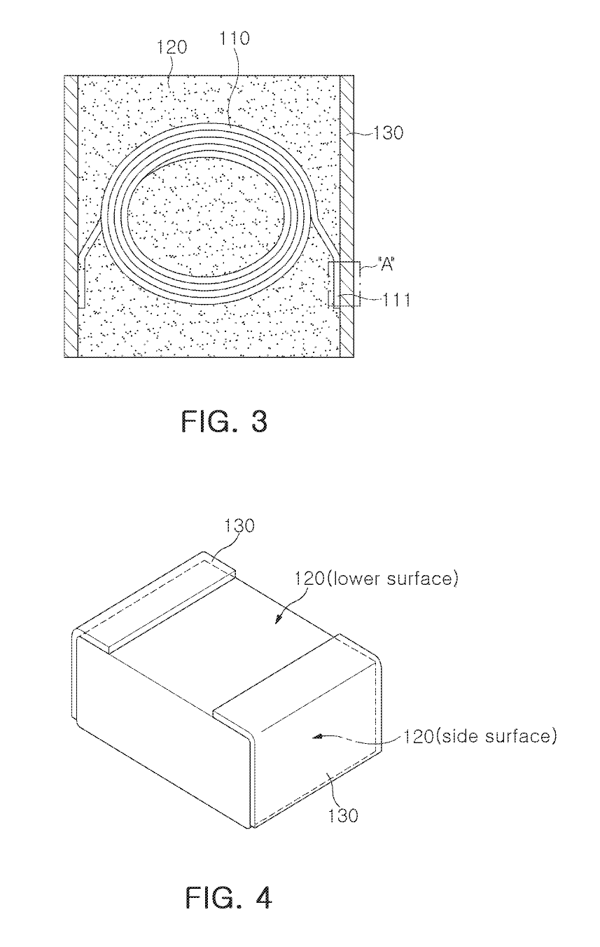

FIGS. 3 and 4 are views illustrating a structure of external electrodes according to another exemplary embodiment.

As illustrated in FIGS. 3 and 4, the external electrodes 130 may be formed in an L-shape, such that a magnetic flux generated in the coil 110 corresponding to the internal electrodes at the time of applying external power may flow more smoothly.

In an open magnetic circuit structure such as an inductor, a magnetic field component passes up by an outer portion of the body part 120, and in a case in which the external electrodes 130 are formed in an L-shape, since the magnetic field component outside the body part 120 is not blocked in other directions except for the external electrodes on lower and side surfaces of the body part 120, high inductance and Q-value may be implemented.

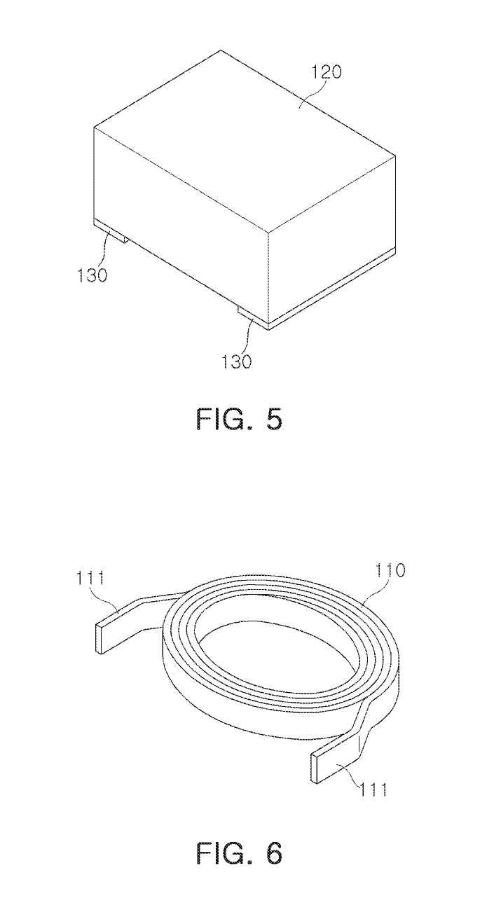

FIG. 5 is a view illustrating a structure of external electrodes according to another exemplary embodiment.

As illustrated in FIG. 5, external electrodes 130 may only be formed on a lower surface of the body part 120. In this case, the lead terminals 111 of the coil 110 may be led out to the lower surface of the body part 120.

Hereinafter, a manufacturing method of an electronic component according to an exemplary embodiment will be described in detail by way of example.

FIGS. 6 through 8 are process views sequentially illustrating a manufacturing method of an electronic component according to an exemplary embodiment.

Referring to FIGS. 6 through 8, the manufacturing method of an electronic component according to the exemplary embodiment may include steps of: seating a coil 110 in an at least a partially processed space of a pre-manufactured support member; adding a magnetic material-resin composite to the support member and a space around the coil 110, and compressing and curing the added magnetic material-resin composite; exposing at least portions of lead terminals 111 of the coil 110 externally to plate a metal on the exposed lead portions; and forming external electrodes 130 connected to the lead terminals 111 of the coil 110.

In the manufacturing method of an electronic component, the coil 110 may be a winding coil having at least one turn.

According to the exemplary embodiment as described above, internal and external electrodes may be connected to each other using a metallic bond, such that direct current resistance and direct current resistance value distribution may be significantly reduced.

Hereinafter, each process of the manufacturing method according to the present exemplary embodiment will be described in more detail with reference to FIGS. 6 through 8.

First, referring to FIG. 6, in the manufacturing method of an electronic component according to the exemplary embodiment, the coil 110 in which the lead terminals are formed may be prepared. In addition, the coil 110 may be seated in the at least partially processed space of the pre-manufactured support member.

The coil 110 may be a winding coil formed to have at least one turn by a winding method and may be a declination coil.

For example, the coil 110 may be formed by winding upper and lower winding wires in a spiral shape so that a plurality of lead terminals 111 of the coil 110 are positioned at the outermost circumferential surface. The lead terminals 111 of the wound winding wires may be at least partially exposed to side surfaces of the body part 120, such that the coil 110 may be directly connected to the external electrodes 130 by plating the metal.

Further, the lead terminals 111 of the wound winding wires may also be at least partially exposed to a lower surface of the body part 120, such that the coil 110 may also be directly connected to the external electrodes 130.

The coil 110 as described above may be formed by winding the upper and lower winding wires in a spiral shape so that the plurality of lead terminals 111 of the coil 110 are positioned at the outermost circumferential surface as illustrated in FIG. 9. In this case, the plurality of lead terminals 111 of the coil 110 may be led out so as to face each other with winding portions of the coil 110 interposed therebetween. That is, the plurality of lead terminals 111 of the winding wires wound in the spiral shape may be at least partially exposed to one side surface of the body part 120, such that the coil 110 may be connected to the external electrodes 130. The shape of the coil may be variously changed, and is not limited thereto.

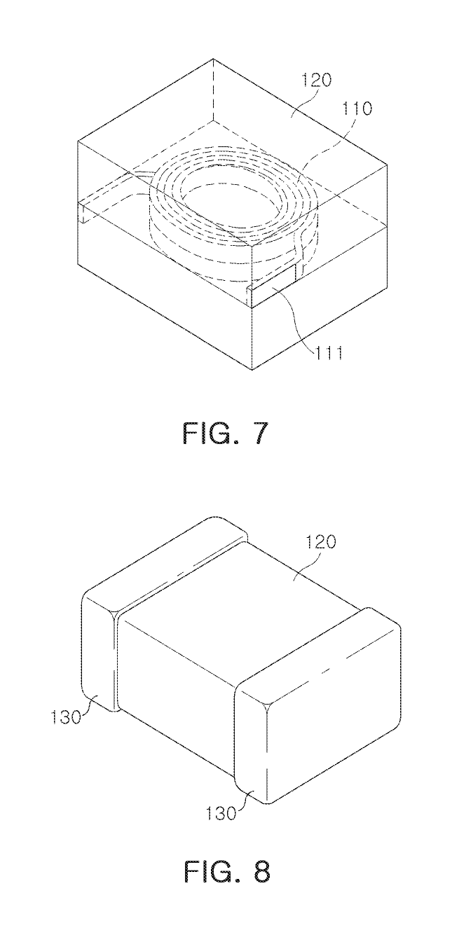

Referring to FIG. 7, the magnetic material-resin composite may be added to the support member and the space around the coil 110, compressed, and then cured. The coil 110 may be embedded using the magnetic material-resin composite in which a magnetic metal powder and a resin mixture are mixed with each other.

In the step of adding the magnetic material-resin composite and compressing and curing the added magnetic material-resin composite, a first magnetic sheet formed by molding the magnetic material-resin composite in which the magnetic metal powder and the resin mixture are mixed with each other in sheet form may be compressed and cured on an upper surface of the support member. Then, a second magnetic sheet formed by molding the magnetic material-resin composite in sheet form may be compressed and cured on a lower surface of the support member.

Next, the lead terminals 111 of the coil 110 may be at least partially exposed externally and may be plated with a metal. In a case in which the lead terminals 111 are embedded by an insulation layer, or the like, the insulation layer, or the like, may be removed using a polishing method, a laser etching method, a peeling method, or the like. That is, the lead terminals 111 of the coil 110 may be at least partially exposed externally in order to plate a metal thereon, and the metal may be plated on the exposed lead terminals 111 of the coil 110.

The lead terminals 111 of the coil 110 may be plated with the metal. For example, pre-plated layers by copper (Cu) plating, or the like, may be formed.

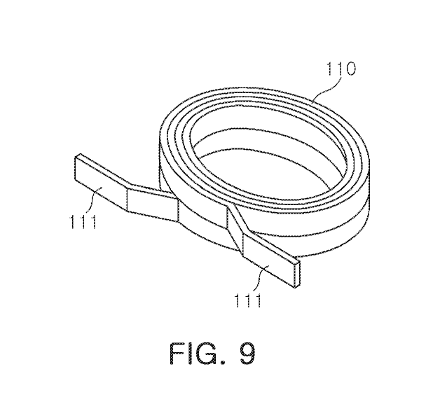

Referring to FIG. 8, the external terminals 130 connected to the lead terminals 111 of the coil 110 by plating the metal may be formed. The lead terminals 111 of the coil 110 may be metallically bonded to the external electrodes 130 by electroplating or electroless plating.

In this case, the external electrodes 130 may contain the metal such as Ag, Ag—Pd, Ni, Cu, or the like, and Ni plating layers and Sn plating layers may be selectively formed on surfaces of the external electrodes 130.

Plating layers 131 formed by directly plating the metal may be formed on the lead terminals 111 of the coil 110. For example, the pre-plating layers formed by copper (Cu) plating, or the like, may be formed. In addition, the external electrodes 130 may be formed by applying at least one of Ni and Sn to the pre-plating layers or by applying at least one of Ag and Cu to the pre-plating layers and then applying at least one of Ni and Sn thereto. For example, plating layers 131 may be formed on external surfaces of lead terminals 111 of a Cu coil, and Ni plating layers 132 and Sn layers 133 may be applied thereto, thereby forming the external electrodes 130.

In this case, the external electrodes 130 may be formed in a general shape to enclose both ends of the body part 120. The external electrodes 130 may be formed in an L-shape, such that a magnetic flux generated in the coil 110 corresponding to internal electrodes at the time of applying external power may flow more smoothly. In an open magnetic circuit structure such as an inductor, there is a magnetic field component passing up to an outer portion of the body part 120. In a case in which the external electrodes 130 are formed in an L-shape, the magnetic field component outside the body part 120 is not blocked in other directions except for external electrodes on the lower and side surfaces of the body part 120. Thus, high inductance and a high Q-value may be implemented.

In addition, the external electrodes 130 may only be formed on a lower surface of the body part 120. In this case, the lead terminals 111 of the coil 110 may be led to the lower surface of the body part 120.

Mechanical and electrical properties generated using a conductive paste may be improved by directly connecting the internal electrodes exposed externally and portions of the body part by the metallic bond through electroplating or electroless plating as described above.

While exemplary embodiments have been shown and described above, it will be apparent to those skilled in the art that modifications and variations could be made without departing from the scope of the present invention as defined by the appended claims.

What is claimed is:

1. An electronic component comprising:
a coil including lead terminals plated with a metal;
a body part filling a space around the coil; and
external electrodes connected to the lead terminals of the coil,
wherein at least portions of the lead terminals of the coil are exposed externally of the body part.

2. The electronic component of claim 1, wherein the external electrodes are disposed on lower and side surfaces of the body part in an L-shape.

3. The electronic component of claim 1, wherein the external electrodes are disposed only on a lower surface of the body part.

4. The electronic component of claim 1, wherein the coil is a winding coil having at least one turn.

5. The electronic component of claim 1, wherein pre-plating layers containing Cu are disposed on the lead terminals of the coil.

6. The electronic component of claim 5, wherein the external electrodes comprise at least one of Ni and Sn disposed on the pre-plating layers or at least one of Ag and Cu disposed on the pre-plating layers and at least one of Ni and Sn thereon.

7. The electronic component of claim 1, further comprising a support member in which the coil is disposed or fixed to an at least partially processed space.

8. The electronic component of claim 1, wherein the body part is formed of a magnetic material-resin composite in which a magnetic metal powder and a resin mixture are mixed with each other.

9. The electronic component of claim 8, wherein the magnetic material-resin composite is molded in sheet form, stacked on at least one surface of the support member, compressed, and then cured.

10. A manufacturing method of an electronic component, the manufacturing method comprising steps of:
seating a coil in an at least partially processed space of a pre-manufactured support member;
adding a magnetic material-resin composite to the support member and a space around the coil, and compressing and curing the added magnetic material-resin composite to forma body part;
exposing at least portions of lead terminals of the coil externally of the body part;
plating a metal on the exposed portions; and
forming external electrodes connected to the lead terminals of the coil.

11. The manufacturing method of claim 10, wherein the external electrodes are formed on lower and side surfaces of the body part in an L-shape.

12. The manufacturing method of claim 10, wherein the external electrodes are formed only on a lower surface of the body part.

13. The manufacturing method of claim 10, wherein in the step of plating the metal, pre-plating layers are formed on the lead terminals of the coil using Cu plating.

14. The manufacturing method of claim 10, wherein in the step of forming the external electrodes, the external electrodes are formed by applying at least one of Ni and Sn on the lead terminals of the coil or by applying at least one of Ag and Cu to the lead terminals of the coil and then applying at least one of Ni and Sn thereto.

15. The manufacturing method of claim 10, wherein the step of plating the metal includes:
exposing at least portions of the lead terminals of the coil externally of the body part; and
plating the metal on the lead terminals of the coil exposed externally.

16. The manufacturing method of claim 10, wherein the step of adding the magnetic material-resin composite and compressing and curing the added magnetic material-resin composite includes:
compressing and curing a first magnetic sheet formed by molding the magnetic material-resin composite in which a magnetic metal powder and a resin mixture are mixed with each other in sheet form on an upper surface of the support member; and
compressing and curing a second magnetic sheet formed by molding the magnetic material-resin composite in sheet form on a lower surface of the support member.
